(19) United States
(12) Patent Application Publication
(10) Pub. No.: US 2003/0179827 A1
(43) Pub. Date: Sep. 25, 2003

(54) Video emphasis encoding method and apparatus, video de-emphasis decoding method and apparatus, video emphasis transmitting method and apparatus and video de-emphasis receiving method and apparatus

(76) Inventor: Kenji Sugiyama, Yokosuka-Shi (JP)

Correspondence Address: JACOBSON HOLMAN, PROFESSIONAL LIMITED LIABILITY COMPANY, 400 Seventh Street, N.W., Washington, DC, 20004, US

(21) Appl. No.: 10/390,671

(22) Filed: Mar. 19, 2003

(30) Foreign Application Priority Data
Mar. 19, 2002 (JP) 2002-076365

(51) Int. Cl. H04N 7/12

(52) U.S. Cl. 375/240.29; 375/240.27; 348/625

(57) ABSTRACT

Video-emphasis encoding processing generates a high-frequency-emphasized video signal by emphasizing high-frequency components of an input video signal and encoding the high-frequency-emphasized video signal, to generate a bitstream of the video signal. Detected in this processing are spatial high-frequency components related to the input video signal, per portion of a picture carried by the input video signal. A high-frequency-component emphasizing level related to the video signal is set per portion of the picture in accordance with levels of the detected high-frequency components. The detected high-frequency components are emphasized in accordance with the set emphasizing level, to generate the high-frequency-emphasized video signal. Orthogonal transform coding is applied to the high-frequency-emphasized video signal per block of the picture, to generate the bitstream. In video de-emphasis processing, inverse orthogonal transform decoding is applied to the bitsteam per block of the picture, to obtain decoded high-frequency-emphasized video signal. Spatial high-frequency components related to the decoded high-frequency-emphasized video signal are detected per portion of the picture. A high-frequency-component de-emphasizing level related to the decoded high-frequency-emphasized video signal is set per portion of the picture in accordance with levels of the detected high-frequency components. The detected high-frequency components are de-emphasized per portion of the picture in accordance with the set de-emphasizing level, to generate the decoded video signal.

### BACKGROUND OF THE INVENTION

The present invention relates to techniques for achieving high image quality with emphasis processing before encoding and de-emphasis processing after decoding in highly efficient encoding for converting video information into digital signals with low code amount in video transfer, storage and display.

An emphasis processing is a known technique widely used in transfer and storage of video and audio signals. In detail, an emphasis circuit gives emphasis effects on high-frequency components of-video or audio signals before transfer or storage.

The emphasized high-frequency components are attenuated by a de-emphasis circuit after transfer or storage for regaining the frequency characteristics which the video or audio signals have exhibited before transferred. Noises and aliasing generated during transfer or storage can be attenuated only by a de-emphasis processing.

The emphasis processing could cause an overrange condition on high-frequency-component-emphasized video or audio signals against signal transfer or storage.

The emphasis processing is, however, useful for highly-efficient encoding processing such as discrete cosine transform (DCT), for less block distortion and mosquito noises which may otherwise be generated during encoding and decoding. This processing may not achieve high coding efficiency due to large quantization errors which will be produced at a fixed amount of code when high-frequency components are emphasized thus generating a large amount of data. Nevertheless, the emphasis processing suppresses block noises because this processing is applied over blocks, different from DCT-encoding and decoding.

Adaptive filtering for eliminating noises and distortion on decoded pictures (post processing) may not be efficient because signal components could also be filtered during noise/aliasing suppression.

In a known video-emphasis encoding processing, an input video signal is subjected to delay, spatial high-pass filtering and activity detection.

The high-frequency (HF) components of the input video signal are extracted through spatial high-pass filtering. The extracted HF components are added to the input video signal that has been delayed for the period of spatial high-pass filtering, thus a HF-component-emphasized signal being produced. The emphasized signal is subjected to (8×8)-DCT and quantization.

Detected before quantization are activities, such as, the levels of video-signal components distributed over each block.

Quantization step width is set, in accordance with activity per block of the video signal, so that blocks at low activity will be subjected to fine quantization whereas those at high activity will be subjected to rough quantization.

The DCT coefficients obtained through (8×8)-DCT are then subjected to quantization at the set quantization step width, thus converted into fixed-length codes. The fixed-length codes are compressed with variable-length code, thus converted into output bitstreams.

In a known video de-emphasis decoding processing compatible with the video-emphasis encoding processing described above, input bitstreams are subjected to variable-length decoding, thus reconverted into fixed-length codes.

The fixed-length codes are subjected to dequantization, thus converted (reproduced) into DCT coefficients, in accordance with input information on quantization step width used for quantization in the video-emphasis encoding processing.

The reproduced DCT coefficients are subjected to (8×8)-inverse-DCT, thus converted (decoded) into a video signal.

The decoded video signal is subjected to delay and spatial high-pass filtering.

The high-frequency (HF) components of the decoded video signal are extracted through spatial high-pass filtering. The extracted HF components are subtracted from the decoded video signal that has been delayed for the period of spatial high-pass filtering, thus a video signal having the frequency characteristics identical to that before emphasis processing being produced.

The code amount will, however, be increased due to increase in high-frequency components of the video signal through the known video-emphasis encoding processing.

Decrease in code amount by rough quantization will increase quantization noises that cannot be suppressed enough by de-emphasis processing after decoding.

Moreover, the known video-emphasis encoding processing easily causes overrange condition on video signals having many high-frequency components.

The known video-emphasis encoding is further disadvantageous in complex processing in adaptive quantization in accordance with activity of videos signals, and also in transfer of per-block quantization information in addition to output video signals.

### SUMMARY OF THE INVENTION

A purpose of the present invention is to provide video-emphasis encoding apparatus and method, and video de-emphasis decoding apparatus and method for enhanced subjective picture quality with quantization processing in accordance with the portion of picture but no quantization step-width adjustments.

The present invention provides a video-emphasis encoding method of generating a high-frequency-emphasized video signal by emphasizing high-frequency components of an input video signal and encoding the high-frequency-emphasized video signal, thus generating a bitstream of the video signal, the method comprising the steps of: detecting spatial high-frequency components related to the input video signal, per portion of a picture carried by the input video signal; setting a high-frequency-component emphasizing level related to the video signal, per portion of the picture, in accordance with levels of the detected high-frequency components; emphasizing the detected high-frequency components in accordance with the set high-frequency-component emphasizing level, thus generating the high-frequency-emphasized video signal; and applying orthogonal transform coding to the high-frequency-emphasized video signal per block of the picture, thus generating the bitstream of the video signal.

Moreover, the present invention provides a video de-emphasis decoding method of decoding a bitsteam to obtain decoded high-frequency-emphasized video signal, the bitstream being produced by emphasizing spatial high-frequency components of a video signal in accordance with the levels of the high-frequency components to generate a high-frequency-emphasized video signal and encoding the high-frequency-emphasized video signal, and the method further de-emphasizing emphasized high-frequency components of the decoded high-frequency-emphasized video signal, thus obtaining a decoded video signal, the method comprising the steps of: applying inverse orthogonal transform decoding to the bitsteam per block of a picture carried by the video signal, to obtain the decoded high-frequency-emphasized video signal; detecting spatial high-frequency components related to the decoded high-frequency-emphasized video signal, per portion of the picture; setting a high-frequency-component de-emphasizing level related to the decoded high-frequency-emphasized video signal, per portion of the picture, in accordance with levels of the detected high-frequency components; and generating the decoded video signal by de-emphasizing the detected high-frequency components, per portion of the picture, in accordance with the set high-frequency-component de-emphasizing level.

Furthermore, the present invention provides a video-emphasis encoding apparatus for generating a high-frequency-emphasized video signal by emphasizing high-frequency components of an input video signal and encoding the high-frequency-emphasized video signal, thus generating a bitstream of the video signal, the apparatus comprising: a detector to detect spatial high-frequency components related to the input video signal, per portion of a picture carried by the input video signal; a level setter to set a high-frequency-component emphasizing level related to the video signal, per portion of the picture, in accordance with levels of the detected high-frequency components; an emphasizer to emphasize the detected high-frequency components in accordance with the set high-frequency-component emphasizing level, thus generating the high-frequency-emphasized video signal; and an encoder to apply orthogonal transform coding to the high-frequency-emphasized video signal per block of the picture, thus generating the bitstream of the video signal.

Moreover, the present invention provides a video de-emphasis decoding apparatus for decoding a bitsteam to obtain decoded high-frequency-emphasized video signal, the bitstream being produced by emphasizing spatial high-frequency components of a video signal in accordance with the levels of the high-frequency components to generate a high-frequency-emphasized video signal and encoding the high-frequency-emphasized video signal, and the method further de-emphasizing emphasized high-frequency components of the decoded high-frequency-emphasized video signal, thus obtaining a decoded video signal, the apparatus comprising: a decoder to apply inverse orthogonal transform decoding to the bitsteam per block of a picture carried by the video signal, to obtain the decoded high-frequency-emphasized video signal; a detector to detect spatial high-frequency components related to the decoded high-frequency-emphasized video signal, per portion of the picture; a level setter to set a high-frequency-component de-emphasizing level related to the decoded high-frequency-emphasized video signal, per portion of the picture, in accordance with levels of the detected high-frequency components; and a de-emphasizer to de-emphasize the detected high-frequency components, per portion of the picture, in accordance with the set high-frequency-component de-emphasizing level, thus obtaining the decoded video signal.

Furthermore, the present invention provides a video-emphasis transmitting method of generating a high-frequency-emphasized video signal by emphasizing high-frequency components of an input video signal and encoding the high-frequency-emphasized video signal, thus generating a bitstream of the video signal, and transmitting the bitstream as packets, the method comprising the steps of: detecting spatial high-frequency components related to the input video signal, per portion of a picture carried by the input video signal; setting a high-frequency-component emphasizing level related to the video signal, per portion of the picture, in accordance with levels of the detected high-frequency components; emphasizing the detected high-frequency components in accordance with the set high-frequency-component emphasizing level, thus generating the high-frequency-emphasized video signal; applying orthogonal transform coding to the high-frequency-emphasized video signal per block of the picture, thus generating the bitstream of the video signal; and forming the packets of the bitstream per data amount, thus generating a packet multiplex signal.

Moreover, the present invention provides a video de-emphasis receiving method of decoding a transmitted packet signal carrying a bitsteam to obtain decoded high-frequency-emphasized video signal, the bitstream being produced by emphasizing spatial high-frequency components of a video signal in accordance with the levels of the high-frequency components to generate a high-frequency-emphasized video signal and encoding the high-frequency-emphasized video signal, and the method further de-emphasizing emphasized high-frequency components of the decoded high-frequency-emphasized video signal, thus obtaining a decoded video signal, the method comprising the steps of: extracting the bitstream from the packet signal; applying inverse orthogonal transform decoding to the bitsteam per block of a picture carried by the video signal, to obtain the decoded high-frequency-emphasized video signal; detecting spatial high-frequency components related to the decoded high-frequency-emphasized video signal, per portion of the picture; setting a high-frequency-component de-emphasizing level related to the decoded high-frequency-emphasized video signal, per portion of the picture, in accordance with levels of the detected high-frequency components; and generating the decoded video signal by de-emphasizing the detected high-frequency components, per portion of the picture, in accordance with the set high-frequency-component de-emphasizing level.

Furthermore, the present invention provides a video-emphasis transmitting apparatus for generating a high-frequency-emphasized video signal by emphasizing high-frequency components of an input video signal and encoding the high-frequency-emphasized video signal, thus generating a bitstream of the video signal, and transmitting the bitstream as packets, the apparatus comprising: a detector to detect spatial high-frequency components related to the input video signal, per portion of a picture carried by the input video signal; a level setter to set a high-frequency-component emphasizing level related to the video signal, per portion of the picture, in accordance with levels of the detected high-frequency components; an emphasizer to emphasize the detected high-frequency components in accordance with the set high-frequency-component emphasizing level, thus generating the high-frequency-emphasized video signal; an encoder to apply orthogonal transform coding to the high-frequency-emphasized video signal per block of the picture, thus generating the bitstream of the video signal; and a packet former to form the packets of the bitstream per data amount, thus generating a packet multiplex signal.

Moreover, the present invention provides a video de-emphasis receiving apparatus for decoding a transmitted packet signal carrying a bitsteam to obtain decoded high-frequency-emphasized video signal, the bitstream being produced by emphasizing spatial high-frequency components of a video signal in accordance with the levels of the high-frequency components to generate a high-frequency-emphasized video signal and encoding the high-frequency-emphasized video signal, and the method further de-emphasizing emphasized high-frequency components of the decoded high-frequency-emphasized video signal, thus obtaining a decoded video signal, the apparatus comprising: an extractor to extract the bitstream from the packet signal; a decoder to apply inverse orthogonal transform decoding to the bitsteam per block of a picture carried by the video signal, to obtain the decoded high-frequency-emphasized video signal; a detector to detect spatial high-frequency components related to the decoded high-frequency-emphasized video signal, per portion of the picture; a level setter to set a high-frequency-component de-emphasizing level related to the decoded high-frequency-emphasized video signal, per portion of the picture, in accordance with levels of the detected high-frequency components; and a de-emphasizer to de-emphasize the detected high-frequency components, per portion of the picture, in accordance with the set high-frequency-component de-emphasizing level, thus generating the decoded video signal.

### BRIEF DESCRIPTION OF DRAWINGS

FIG. 1 shows a block diagram of a first embodiment of video-emphasis encoding apparatus according to the present invention;

FIG. 2 shows tap coefficients for a high-pass filter in the first embodiment of video-emphasis encoding apparatus;

FIGS. 3A and 3B show frequency characteristics in the first embodiment of video-emphasis encoding apparatus;

FIG. 4 shows tap coefficients for a low-pass filter in the first embodiment of video-emphasis encoding apparatus;

FIG. 5 shows emphasis control characteristics in the first embodiment of video-emphasis encoding apparatus;

FIG. 6 shows a block diagram of a first embodiment of video de-emphasis decoding apparatus according to the present invention;

FIG. 7 shows tap coefficients for a high-pass filter in the first embodiment of video de-emphasis decoding apparatus;

FIG. 8 shows de-emphasis control characteristics in the first embodiment of video de-emphasis decoding apparatus;

FIG. 9 shows frequency characteristics in the first embodiment of video de-emphasis decoding apparatus;

FIG. 10 shows a block diagram of a second embodiment of video-emphasis encoding apparatus according to the present invention;

FIG. 11 shows a block diagram of a second embodiment of video de-emphasis decoding apparatus according to the present invention;

FIG. 12 shows a block diagram of an embodiment of video-emphasis transmitting apparatus according to the present invention; and

FIG. 13 shows a block diagram of an embodiment of video de-emphasis receiving apparatus according to the present invention.

### DETAILED DESCRIPTION OF PREFERRED EMBODIMENTS

Preferred embodiments according to the present invention will be disclosed with reference to the attached drawings.

[First embodiment of Video-Emphasis Encoding Apparatus]

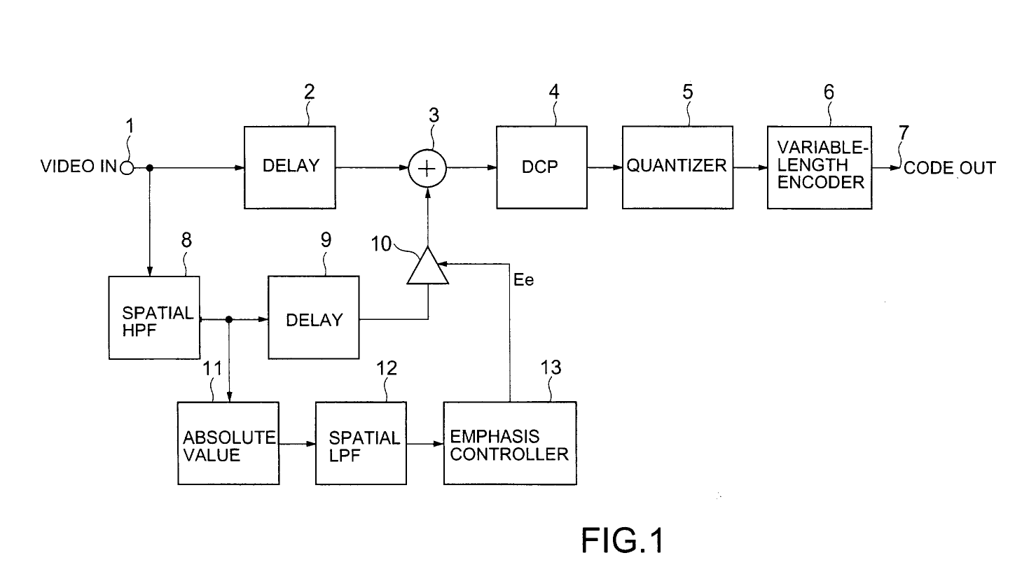

In FIG. 1, an input video signal is supplied to a delayer 2 and a spatial high-pass filter (HPF) 8 via an input terminal 1.

High-frequency components are extracted from the input video signal by the spatial HPF 8 with specific filtering characteristics which will be disclosed later.

The extracted high-frequency components are supplied to a delayer 9 and also an absolute-value converter 11.

The absolute-value converter 11 produces an absolute signal of positive level with conversion of high-frequency components of negative level into those of positive level.

The absolute signal is supplied to a spatial LPF 12 for suppression of high-frequency components carried by the absolute signal.

The high-frequency-component-suppressed signal is supplied to an emphasis controller 13 for generating an emphasis-level (Ee) signal indicating the degree of emphasis.

The emphasis-level signal is supplied to a multiplier 10. Also supplied to the multiplier 10 are high-frequency components of the input video signal delayed by the delayer 9. Based on the delayed high-frequency components and the emphasis-level signal, the multiplier 10 produces a video signal with high-frequency components adjusted in accordance with the emphasis level Ee.

The video signal is then supplied to an adder 3 from the multiplier 10 and added to the input video signal delayed by the delayer 2, thus a high-frequency-component-emphasized video signal being produced.

The delayer 9 is employed for compensating for delay caused through processing by the absolute-value converter 11, the spatial LPF 12 and the emphasis controller 13. The high-frequency components supplied from the delayer 9 to the multiplier 10 are synchronized with the output of the emphasis controller 13.

The video signal for which the high-frequency components have been emphasized is supplied from the adder 3 to a DCT (discrete cosign transform) 3 for an (8×8)-DCT conversion processing.

The resultant DCT coefficients are supplied to a quantizer 5. The DCT coefficients are quantized at a specific step width to become fixed-length codes. The fixed-length codes of the DCT coefficients are supplied to a variable-length encoder 6 for compression with variable-length codes. The resultant video bitstream is output from a code output terminal 7, as an output video signal.

Disclosed next is the spatial HPF 8 for giving emphasis characteristics to the high-frequency components of the input video signal per portion of picture.

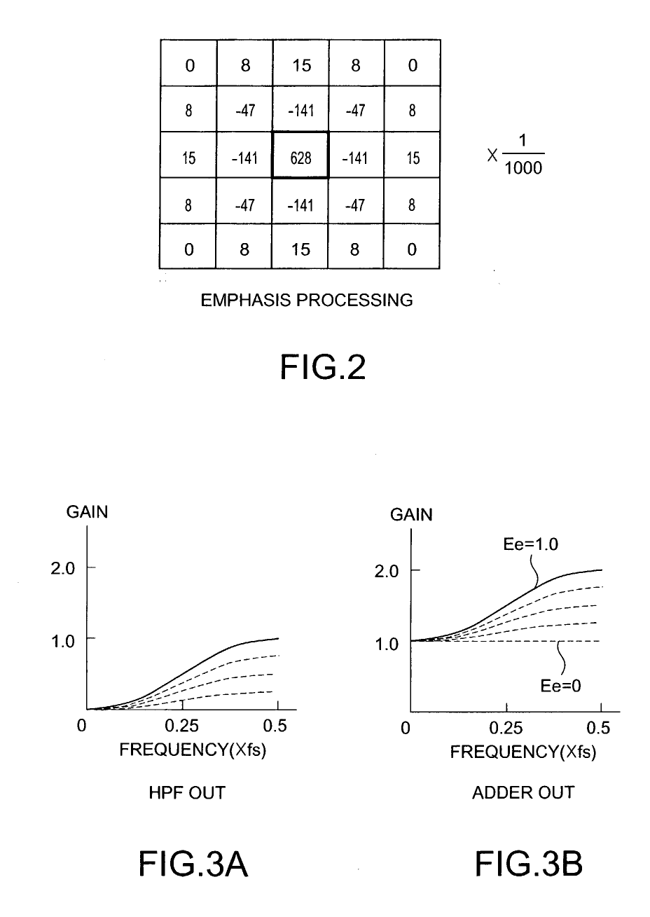

Illustrated in FIG. 2 are 1000× tap coefficients per block of pixels applied to the spatial HPF 8 for giving emphasis characteristics. An actual tap coefficient is obtained by multiplying each value shown in FIG. 2 by 1/000.

Shown in FIGS. 3A and 3B are frequency characteristics given to the video signal for which the high-frequency components have been emphasized through the adder 3, based on the high-frequency components that have passed through the spatial HPF 8.

FIGS. 3A and 3B show one-dimensional frequency characteristics in the spatial vertical or horizontal direction, representing the spatial frequency characteristics discussed above.

In FIGS. 3A and 3B, the axis of abscissas and ordinate indicate video-signal frequency to a sampling frequency and signal gain, respectively. Shown in FIG. 3A is filtering characteristics applied to the spatial HPF 8 whereas FIG. 3B frequency characteristics given to the video signal through the adder 3, with emphasis levels Ee as parameters.

In detail, the frequency characteristics is flat at the emphasis level 0, but it is two times higher at the emphasis level 1.0 for the highest frequency.

The high-frequency components from the delayer 9 are multiplied by an emphasis level Ee in the range from 0 to 1.0, at the multiplier 10, the resultant signal of which high-frequency components have been emphasized being supplied to the adder 3.

The high-frequency-component emphasis processing is thus performed in accordance with the emphasis level Ee that is set by the emphasis controller 13 based on a signal obtained by the absolute-value converter 11 and smoothed by the spatial LPF 12.

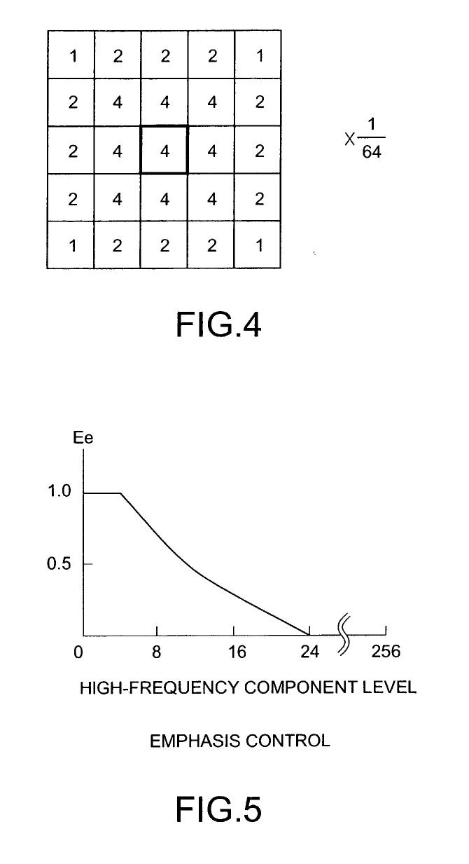

Illustrated in FIG. 4 are 64×tap coefficients per block of pixels applied to the spatial LPF 12 for smoothing processing discussed above. An actual tap coefficient is obtained by multiplying each value shown in FIG. 4 by 1/64.

The absolute-value signal obtained by the absolute-value converter 11 is smoothed by the spatial LPF 12 with the tap coefficients shown in FIG. 4, thus converted into a signal having the high-frequency-component level that varies gently over pixels.

The output of the spatial LPF 12 is then supplied to the emphasis controller 13 for nonlinear conversion. The nonlinear-converted signal carries the emphasis level Ee.

Illustrated in FIG. 5 is nonlinear-conversion characteristics given to the emphasis controller 13.

The emphasis level Ee is 1.0 at a first predetermined high-frequency level, for example, 4 or lower whereas 0 at a second predetermined high-frequency level, for example, 24 or higher.

As disclosed above, the first embodiment of video-emphasis encoding apparatus applies emphasis processing to an input video signal, based on the emphasis level Ee obtained in accordance with the level of spatial high-frequency components detected through input-video spatial high-pass filtering, and further applies orthogonal transform, quantization and variable-length encoding to the emphasized signal, to output a bitstream of video signal.

[First embodiment of Video De-Emphasis Decoding Apparatus]

Disclosed next is the first embodiment of video de-emphasis decoding apparatus according to the present invention, that receives a bitstream of video signal supplied, for example, by the video-emphasis encoding apparatus, shown in FIG. 1.

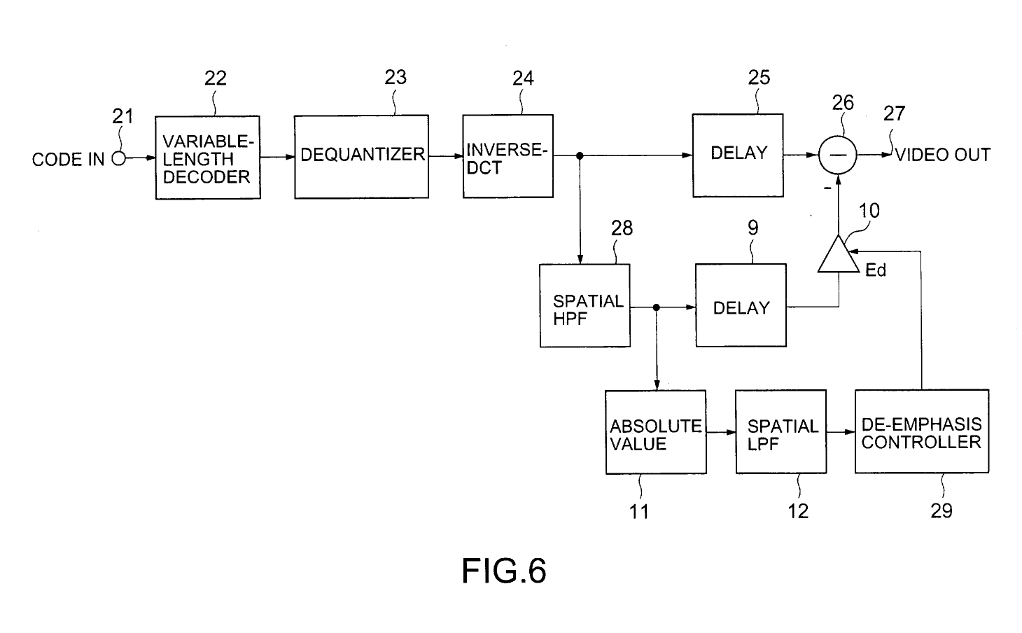

The circuit components (FIG. 6) identical to those in FIG. 1 are given the same reference numerals.

In FIG. 6, the bitstream of video signal is supplied to a variable-length decoder 22.

Variable-length codes of the input bitstream are converted into fixed-length codes by the variable-length decoder 22 complementary working with the variable-length encoder 6 (FIG. 1).

The fixed-length codes are supplied to a dequantizer 23 for reproduction of (8×8)-DCT coefficients of predictive errors. The (8×8) number of DCT coefficients are converted by an inverse-DCT 24 for reproduction of a predictive-error signal. The reproduced predictive-error signal is supplied to a subtractor 26 after delayed by a delayer 25 and also a spatial HPF 28 directrly.

High-frequency components of the predictive-error signal pass through the spatial HPF 28 and supplied to a multiplier 10 after delayed by a delayer 9. Also supplied to the multiplier 10 is a signal from a de-emphasis controller 29.

A signal for which high-frequency components have been emphasized is supplied from the multiplier 10 to a subtractor 26. The high-frequency-component-emphasized signal is subtracted from the reproduced predictive-error signal also supplied to the subtractor 25 through the delayer 25.

The resultant reproduced predictive-error signal, or an output video signal, is supplied to an output terminal 27 through de-emphasis processing disclosed below.

In de-emphasis processing, the spatial HPF 28 extracts only the high-frequency components from the reproduced signal. The frequency characteristics for the spatial HPF 28 is similar to that for the spatial HPF 8 but not identical.

The difference in frequency characteristics for the spatial HPFs 8 and 28 lies in flat frequency characteristics which should be given to the video signal of the video de-emphasis decoding apparatus (FIG. 6), applied the de-emphasis characteristics following to the emphasis characteristics.

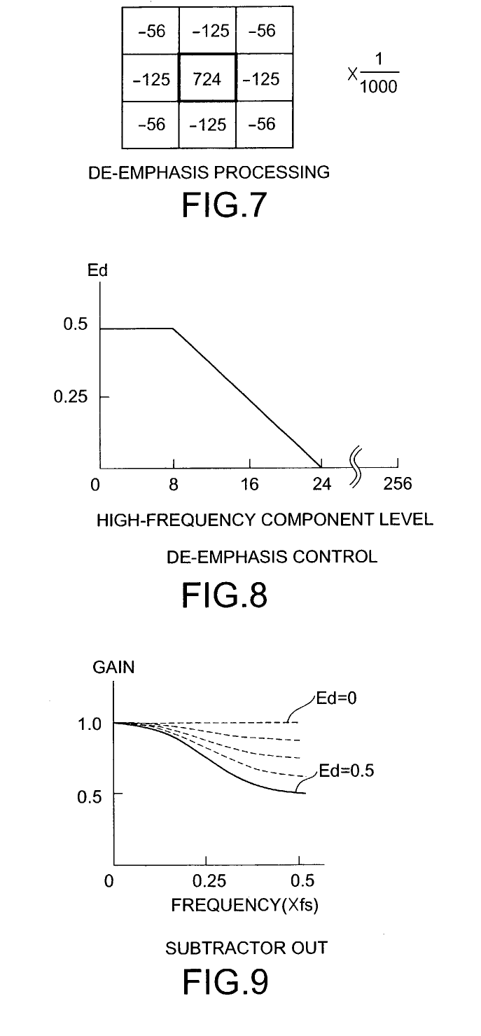

Illustrated in FIG. 7 are 1000×tap coefficients per block of pixels applied to the spatial HPF 28 for allowing high-frequency components to pass therethrough. An actual tap coefficient is obtained by multiplying each value shown in FIG. 7 by 1/000.

The number of tap coefficients for the spatial HPF 28 (decoding apparatus) shown in FIG. 7 is smaller than that for the spatial HPF 8 (encoding apparatus) shown in FIG. 2. The larger number of tap coefficients for the spatial HPF 8 in encoding compensates for the frequency characteristics which would otherwise be degraded due to processing by the spatial HPF 28 in decoding.

The output signal of the spatial HPF 28 having the tap coefficients (FIG. 7) is supplied to the multiplier 10 through the delayer 9 as described above and also to the absolute-value converter 11, as shown in FIG. 6.

The absolute-value converter 11 produces an absolute signal of positive level with conversion of high-frequency components of negative level into those of positive level.

The absolute signal is supplied to the spatial LPF 12 having the tap coefficients shown in FIG. 4. Low-frequency components of the absolute signal are extracted through smoothing processing at the spatial LPF 12.

The smoothed signal is supplied to the de-emphasis controller 29 for generating a de-emphasis-level (Ed) signal to the multiplier 10, which will give a particular characteristics (discussed later) to the decoded video signal.

The output of the delayer 9 is then multiplied by the de-emphasis-level signal from the de-emphasis controller 29 and supplied to the subtractor 26, thus a de-emphasized predictive-error signal being produced.

FIG. 8 shows the relationship between the level of high-frequency components carried by a reproduced predictive-error signal and a deempahsis level Ed for applying deempahsis processing to the predictive-error signal.

The de-emphasis level Ed is 0.5 for the high-frequency level at a first predetermined level, for example, 8 or lower whereas 0 at a second predetermined level, for example, 24 or higher. The level Ed between the first and the second levels varies linearly.

The high-frequency components subjected to multiplication with the de-emphasis level Ed (0 to 0.5) is then subtracted from the reproduced predictive-error signal by the subtractor 26.

The video signal output from the subtractor 26 has the frequency characteristics identical to that before the empahsis processing discussed in the first embodiment of encoding apparatus (FIG. 1), based on the multiplication of the high-frequency components by the de-emphasis level Ed.

FIG. 9 shows spatial frequency characteristics for the deempahsis processing discussed above. The axis of abscissas and ordinate indicate video-signal frequency to a sampling frequency and gain for the deempahsis characteristics.

As disclosed above, a bitsteam of video signal subjected to emphasis processing at the video-emphasis encoding apparatus (FIG. 1) is supplied to the video de-emphasis decoding apparatus (FIG. 6) for decoding and de-emphasis processing.

The high-frequency components to be subjected to decoding at the video de-emphasis decoding apparatus have already been emphasized by emphasis processing.

The de-emphasis processing to such emphasized signal requires nonlinear-conversion characteristics for the de-emphasis controller 29.

Comparison is made between the nonlinear-conversion characteristics for the emphasis and de-emphasis processing.

As shown in FIGS. 5 and 8, the nonlinear-conversion characteristics in the de-emphasis processing has the first predetermined level (e.g., 0.5) one-half of that (e.g., 1.0) in the emphasis processing and a second predetermined level (e.g., 0) equal to that in the emphasis processing.

Moreover, different from the nonlinear-conversion characteristics in the emphasis processing, that in the de-emphasis processing is linear between the first and the second levels, as shown in FIG. 8.

Disclosed next are embodiments for achieving further complementary conversion between emphasis and de-emphasis characteristics.

[Second Embodiment of Video-Emphasis Encoding Apparatus]

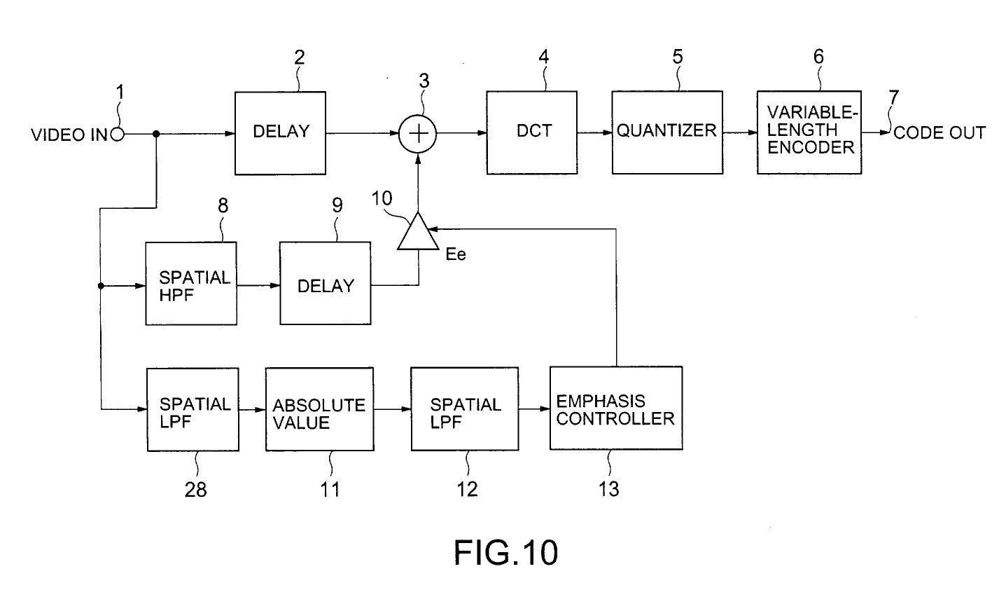

Elements in the second embodiment of video-emphasis encoding apparatus (FIG. 10) the same as or analogous to the elements of the first embodiment (FIG. 1) are given the same reference numerals and will not be explained in detail.

The second embodiment of video-emphasis encoding apparatus is almost identical to the first embodiment (FIG. 1) except that the former has a spatial high-pass filter (HPF) 28, as shown in FIG. 10.

The differences between the first and the second embodiments are as follows:

In the first embodiment, the output of the spatial HPF 8 is used for producing a signal to be added to an input video signal for emphasis processing and also producing a signal to control the emphasis level.

On the contrary, in the second embodiment, the output of the spatial HPF 8 is used for producing a signal to be added to an input video signal for emphasis processing and the output of the spatial HPF 28 is used for producing a signal to control the emphasis level.

Disclosed below is emphasis-level control in the second embodiment, which is a peculiar difference between the first and the second embodiments.

The spatial HPF 8 in the first embodiment of video-emphasis encoding apparatus (FIG. 1) has the tap coefficients shown in FIG. 2. Moreover, the spatial HPF 28 in the first embodiment of video de-emphasis decoding apparatus (FIG. 6) has the tap coefficients shown in FIG. 7.

The spatial HPF 8 of the video-emphasis encoding apparatus and the spatial HPF 28 of the video de-emphasis decoding apparatus allow similar spatial high-frequency components to pass therethrough. Their filtering characteristics are, however, different from each other. This results in a small difference between the high-frequency components passing through the spatial HPFs 8 and 28 for emphasis- and de-emphasis-level control, respectively. Such difference will cause errors in complementary operations in emphasis and de-emphasis processing.

Therefore, the second embodiment of video-emphasis encoding apparatus is equipped with the spatial HPFs 8 and 28 for emphasizing-signal generation and empahsis-level control, respectively. Moreover, the spatial HPF 28 in the second embodiment of video-emphasis encoding apparatus is identical to the spatial HPF 28 in the first embodiment of video de-emphasis decoding apparatus shown in FIG. 6.

The combination of the second embodiment of video-emphasis encoding apparatus (FIG. 10) and the first embodiment of video de-emphasis decoding apparatus (FIG. 6) thus offers well-matched complementary emphasis and de-emphasis characteristics.

[Second Embodiment of Video De-Emphasis Decoding Apparatus]

Disclosed next is a second embodiment of video de-emphasis decoding apparatus having de-emphasis characteristic complementary with the first embodiment of video-emphasis encoding apparatus (FIG. 1).

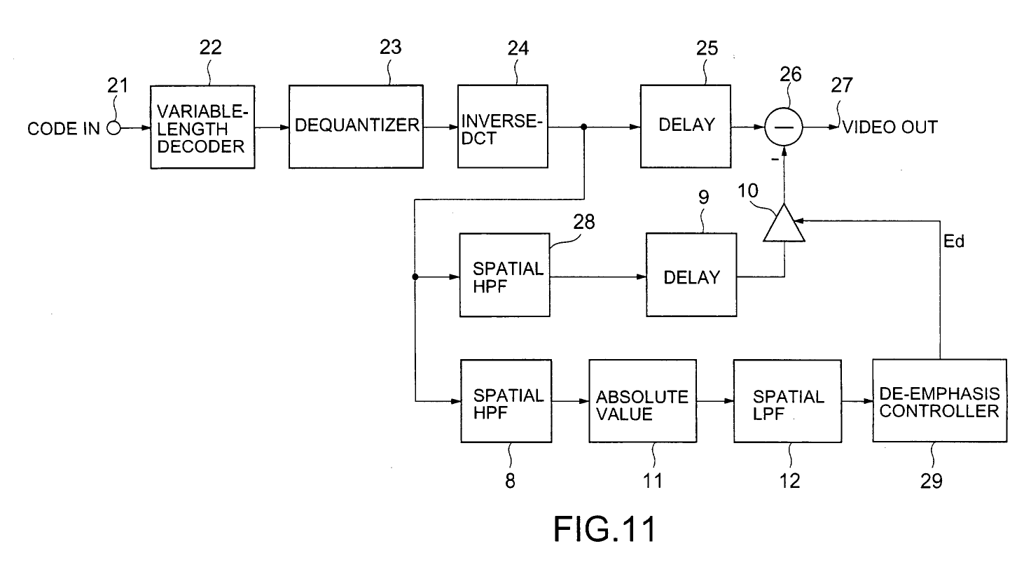

The differences between the first embodiment of video de-emphasis decoding apparatus (FIG. 6) and the second embodiment of video de-emphasis decoding apparatus shown in FIG. 11 are as follows:

In addition to the spatial HPF 28 (FIG. 6), the second embodiment of video de-emphasis decoding apparatus (FIG. 11) has the spatial HPF 8 identical to the counterpart of the first embodiment of video-emphasis encoding apparatus (FIG. 1).

In detail, in FIG. 11, the spatial HPF 28 is used for producing a signal used for de-emphasis processing whereas the spatial HPF 8 is used for producing a signal used for de-emphasis-level control.

The combination of the spatial HPFs 8 and 28 offers de-emphasis characteristics well complementary with the first embodiment of video-emphasis encoding apparatus (FIG. 1).

Disclosed above are the second embodiment of video-emphasis encoding apparatus (FIG. 10) having emphasis characteristics complementary with the first embodiment of video de-emphasis decoding apparatus (FIG. 6) and also the second embodiment of video de-emphasis decoding apparatus (FIG. 11) having de-emphasis characteristics complementary with the first embodiment of video-emphasis encoding apparatus (FIG. 1).

The second embodiment of video-emphasis encoding apparatus (FIG. 10) is compatible with the first embodiment of video de-emphasis decoding apparatus (FIG. 6). The second embodiment of video de-emphasis decoding apparatus (FIG. 11) is compatible with the first embodiment of video-emphasis encoding apparatus (FIG. 1). In other words, the second embodiment of video-emphasis encoding apparatus (FIG. 10) is not compatible with the second embodiment of video de-emphasis decoding apparatus (FIG. 11).

As disclosed above, emphasis-level setting is performed (before encoding) per portion of picture in accordance with high-frequency components of a video signal to be encoded and de-emphasis-level setting is performed (after decoding) per portion of picture in accordance with high-frequency components of a decoded video signal.

The combination of the emphasis- and de-emphasis-level settings allows quantization in accordance with portions of picture but with no quantization step-width adjustments.

Thus, the present invention provides the video-emphasis encoding apparatus and also video de-emphasis decoding apparatus that can offer high subjective picture quality.

Disclosed next are a video-emphasis transmitting apparatus and a video de-emphasis receiving apparatus that transmits and receives video signals processed through the video-emphasis encoding processing, respectively.

[Embodiment of Video-Emphasis Transmitting Apparatus]

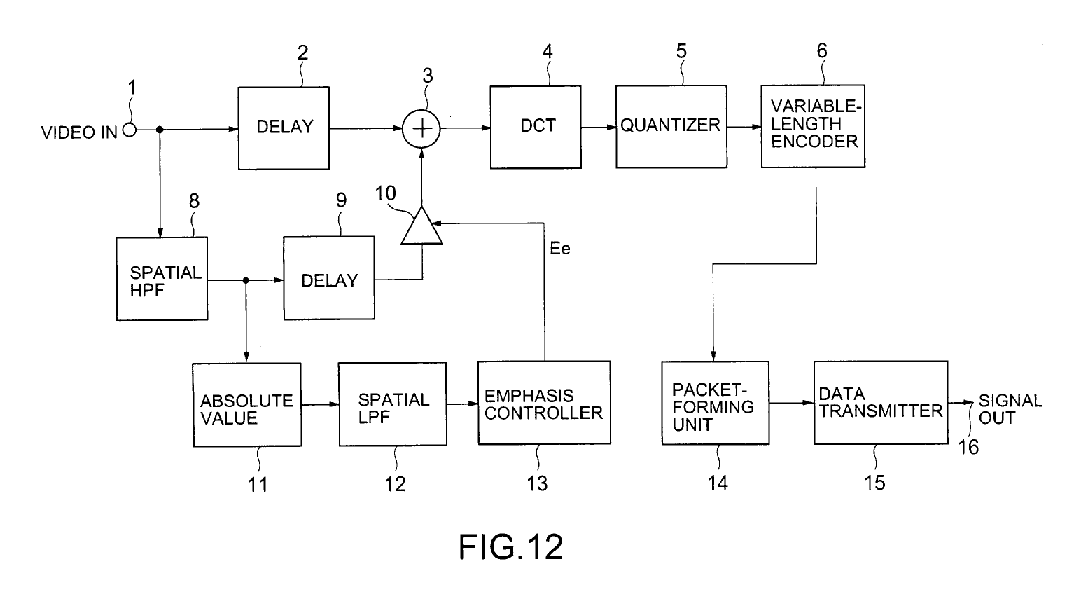

Disclosed next with reference to FIG. 12 is an embodiment of video-emphasis transmitting apparatus.

The video-emphasis transmitting apparatus shown in FIG. 12 is equipped with a bitstream transmitting circuitry in addition to the video-encoding and -emphasizing circuitry identical to that of the first embodiment of video-emphasis encoding apparatus (FIG. 1).

Elements in the video-emphasis transmitting apparatus (FIG. 12) the same as or analogous to the elements of the video-emphasis encoding apparatus (FIG. 1) are given the same reference numerals and will not be explained in detail.

A video bitstream output by the variable-length encoder 6, through the encoding and emphasis processing the same as discussed in the first embodiment of video-emphasis encoding apparatus (FIG. 1), are supplied to a packet forming unit 14, as shown in FIG. 12.

The bitstream is then put into packets per specific length of bitstream by the packet forming unit 14.

Each packet is supplied to a data transmitter 15 for addition of error-correction codes, code modulation, etc., and then transmitted via an output terminal 16, as a packet multiplex signal to be transferred or stored.

The emphasized bitstream output from the video-emphasis transmitting apparatus (FIG. 12) is transferred by wired or wireless transmission.

[Embodiment of Video De-Emphasis Receiving Apparatus]

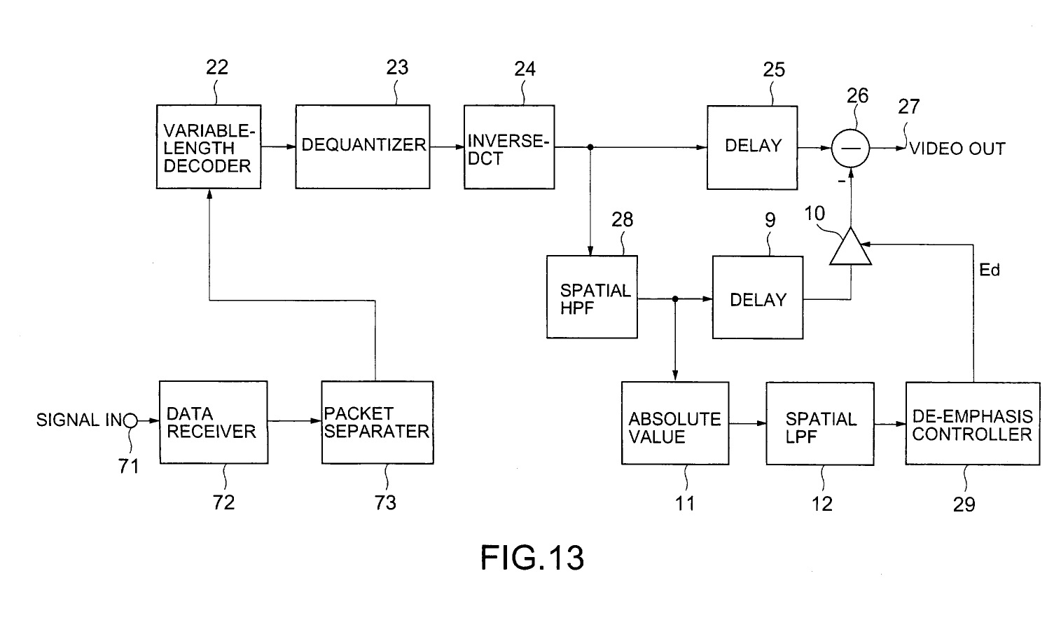

Disclosed next with reference to FIG. 13 is an embodiment of video de-emphasis receiving apparatus.

The video de-emphasis receiving apparatus shown in FIG. 13 is equipped with a bitstream receiving circuitry in addition to the video-decoding and -de-emphasizing circuitry identical to that of the first embodiment of video de-emphasis decoding apparatus (FIG. 6).

Elements in the video de-emphasis receiving apparatus (FIG. 13) the same as or analogous to the elements of the video de-emphasis decoding apparatus (FIG. 6) are given the same reference numerals and will not be explained in detail.

In FIG. 13, a signal transmitted by wired or wireless transmission, for example, from the video-emphasis transmitting apparatus (FIG. 12), is supplied to a data receiver 72 via a signal input terminal 71, for code demodulation and error correction.

A packet signal output by the data receiver 72 is supplied to a packet separator 73. A video bitstream is then extracted from packets and supplied to the variable-length decoder 22. The succeeding decoding and de-emphasis processing are the same as those discussed in the first embodiment of video de-emphasis decoding apparatus (FIG. 6).

As disclosed, according to the video-emphasis transmitting apparatus (FIG. 12), the emphasis level is set per portion of picture carried by a video signal in accordance with high-frequency components of the signal, before encoding processing. The video signal is then emphasized according to the set emphasis level and encoded. These processing are identical to those discussed in the first embodiment of video-emphasis encoding apparatus (FIG. 1).

The encoded video signal is then put in packets for wired or wireless transmission.

The transmitted signal is supplied to the video de-emphasis receiving apparatus (FIG. 13) and extracted from the packets. The extracted video signal is decoded with de-emphasis processing at the de-emphasis level set per portion of picture in accordance with high-frequency components of the video signal, like discussed in the first embodiment of video de-emphasis decoding apparatus (FIG. 6).

Therefore, the present invention achieves high subjective picture quality with quantization processing in accordance with picture portions but no quantization step-width adjustments, through the video-emphasis transmitting apparatus and the video de-emphasis receiving apparatus, disclosed above.

As disclosed above, according to the several embodiments, the emphasis level is set, before encoding, per picture portion in accordance with high-frequency components of a video signal, and the de-emphasis level is set, after decoding, per portion of picture in accordance with high-frequency components of the video signal.

The de-emphasis processing thus cancels the emphasis applied in the encoder side to maintain overall frequency characteristics to the video signal. Moreover, high-frequency components are emphasized for portions of picture having few high-frequency components by the emphasis processing with fine quantization but no step-width adjustments in accordance with picture portions.

Therefore, the emphasis and/or de-emphasis processing according to the present invention offer enhanced picture quality which may otherwise be degraded due to block distortion, mosquito noises, etc.

Moreover, the emphasis level is set at low for portions of picture having many high-frequency components, thus generating almost no overrange conditions which may otherwise be generated during encoding. This emphasis-level control enhances subjective picture quality of encoded video signals transferred at constant bit rate, thus achieving stable picture quality and decrease in transfer bit rate.

Disclosed above are several embodiments of methods and apparatus for obtaining video signals of high subjective picture quality with generation of coded data through DCT transform and variable-length encoding to video signals emphasized at an emphasis level set in accordance with spatial high-frequency components of video pixels, the coded data being transferred via wired or wireless transmission or storage media for decoding and de-emphasis processing complimentary with the emphasis and encoding processing.

The DCT transform and variable-length encoding processing are also applicable to other encoding techniques in JPEG and MPEG, with orthogonal transform of video data to obtain frequency data and suppression of signal components, among the frequency data, which have small effects to subjective picture quality, achieving encoding and decoding processing to video signals of low transfer bit rate.

The present invention also include several programs for causing a computer to work as the video-emphasis encoding apparatus, the video de-emphasis dencoding apparatus, the video-emphasis transmitting apparatus and the video de-emphasis receiving apparatus, disclosed above.

One of the programs is a video-emphasis encoding program with functions of generating a high-frequency-emphasized video signal by emphasizing high-frequency components of an input video signal in accordance with the levels of the high-frequency components and applying orthogonal transform and variable-length encoding to the high-frequency-emphasized video signal, thus generating a bitstream of the video signal.

In detail, the video-emphasis encoding program includes: a program code means for detecting spatial high-frequency components related to the input video signal, per portion of a picture carried by the input video signal; a program code means for setting a high-frequency-component emphasizing level related to the video signal, per portion of the picture, in accordance with levels of the detected high-frequency components; a program code means for emphasizing the detected high-frequency components in accordance with the set high-frequency-component emphasizing level, thus generating the high-frequency-emphasized video signal; and a program code means for applying orthogonal transform coding to the high-frequency-emphasized video signal per block of the picture, thus generating the bitstream of the video signal.

The video-emphasis encoding program can be installed in a computer via network or package media.

As disclosed above, the present invention provides video-emphasis encoding technique to generate a high-frequency-emphasized video signal by emphasizing high-frequency components of an input video signal and encoding the high-frequency-emphasized video signal, thus generating a bitstream of the video signal.

Detected are spatial high-frequency components related to the input video signal, per portion of a picture carried by the input video signal;

A high-frequency-component emphasizing level related to the video signal is set per portion of the picture in accordance with levels of the detected high-frequency components.

The detected high-frequency components are emphasized in accordance with the set high-frequency-component emphasizing level, thus generating the high-frequency-emphasized video signal.

Orthogonal transform coding is applied to the high-frequency-emphasized video signal per block of the picture, thus generating the bitstream of the video signal.

The bitstream may be put in packets per data amount, to generate a packet multiplex signal in transmission.

Thus, the present invention achieves optimum quantization in accordance with the portion of picture to generate encoded video signal of high subjective picture quality.

In detection of the spatial high-frequency components, spatial high-pass filtering may be applied to the input video signal, and in emphasizing the detected high-frequency components, the high-frequency components detected through the spatial high-pass filtering may be added to the video signal.

Single spatial high-pass filtering processing is only required for both emphasis processing and also emphasis-level control.

Thus, the present invention provides economical video-emphasis encoding processing, in addition to the advantages discussed above.

Moreover, the present invention provides video de-emphasis decoding technique to decode a bitsteam to obtain decoded high-frequency-emphasized video signal, the bitstream being produced by emphasizing spatial high-frequency components of a video signal in accordance with the levels of the high-frequency components to generate a high-frequency-emphasized video signal and encoding the high-frequency-emphasized video signal, and further de-emphasize emphasized high-frequency components of the decoded high-frequency-emphasized video signal, thus obtaining a decoded video signal.

Inverse orthogonal transform decoding is applied to the bitsteam per block of a picture carried by the video signal, to obtain decoded high-frequency-emphasized video signal.

Spatial high-frequency components related to the decoded high-frequency-emphasized video signal are detected per portion of the picture;

A high-frequency-component de-emphasizing level related to the decoded high-frequency-emphasized video signal is set per portion of the picture in accordance with levels of the detected high-frequency components.

The decoded video signal is generated by de-emphasizing the detected high-frequency components per portion of the picture in accordance with the set high-frequency-component de-emphasizing level, thus generating the decoded video signal.

The bitstream may be extracted from a packet signal before detection of the spatial high-frequency components, when the bitstream is transmitted as the packet signal.

Thus, the present invention provides video de-emphasis decoding processing to reproduce vide data of high subjective picture quality.

In detection of the spatial high-frequency components, spatial high-pass filtering may be applied to the decoded high-frequency-emphasized video signal, and in generation of the decoded video signal, the high-frequency components detected through the spatial high-pass filtering may be subtracted from the decoded high-frequency-emphasized video signal.

Single spatial high-pass filtering processing is only required for both de-emphasis processing and also de-emphasis-level control.

Thus, the present invention provides economical video de-emphasis decoding processing, in addition to the advantages discussed above.

What is claimed is:

1. A video-emphasis encoding method of generating a high-frequency-emphasized video signal by emphasizing high-frequency components of an input video signal and encoding the high-frequency-emphasized video signal, thus generating a bitstream of the video signal, the method comprising the steps of:
detecting spatial high-frequency components related to the input video signal, per portion of a picture carried by the input video signal;
setting a high-frequency-component emphasizing level related to the video signal, per portion of the picture, in accordance with levels of the detected high-frequency components;
emphasizing the detected high-frequency components in accordance with the set high-frequency-component emphasizing level, thus generating the high-frequency-emphasized video signal; and
applying orthogonal transform coding to the high-frequency-emphasized video signal per block of the picture, thus generating the bitstream of the video signal.

2. The video-emphasis encoding method according to claim 1, wherein:
the step of detecting the spatial high-frequency components includes the step of applying spatial high-pass filtering to the input video signal, and
the step of emphasizing the detected high-frequency components includes the step of adding the high-frequency components detected through the spatial high-pass filtering to the video signal.

3. A video de-emphasis decoding method of decoding a bitsteam to obtain decoded high-frequency-emphasized video signal, the bitstream being produced by emphasizing spatial high-frequency components of a video signal in accordance with the levels of the high-frequency components to generate a high-frequency-emphasized video signal and encoding the high-frequency-emphasized video signal, and the method further de-emphasizing emphasized high-frequency components of the decoded high-frequency-emphasized video signal, thus obtaining a decoded video signal, the method comprising the steps of:
applying inverse orthogonal transform decoding to the bitsteam per block of a picture carried by the video signal, to obtain the decoded high-frequency-emphasized video signal;
detecting spatial high-frequency components related to the decoded high-frequency-emphasized video signal, per portion of the picture;
setting a high-frequency-component de-emphasizing level related to the decoded high-frequency-emphasized video signal, per portion of the picture, in accordance with levels of the detected high-frequency components; and
generating the decoded video signal by de-emphasizing the detected high-frequency components, per portion of the picture, in accordance with the set high-frequency-component de-emphasizing level.

4. The video de-emphasis decoding method according to claim 3, wherein:
the step of detecting the spatial high-frequency components includes the step of applying spatial high-pass filtering to the decoded high-frequency-emphasized video signal; and
the step of generating the decoded video signal includes the step of subtracting the high-frequency components detected through the spatial high-pass filtering from the decoded high-frequency-emphasized video signal.

5. A video-emphasis encoding apparatus for generating a high-frequency-emphasized video signal by emphasizing high-frequency components of an input video signal and encoding the high-frequency-emphasized video signal, thus generating a bitstream of the video signal, the apparatus comprising:
a detector to detect spatial high-frequency components related to the input video signal, per portion of a picture carried by the input video signal;
a level setter to set a high-frequency-component emphasizing level related to the video signal, per portion of the picture, in accordance with levels of the detected high-frequency components;
an emphasizer to emphasize the detected high-frequency components in accordance with the set high-frequency-component emphasizing level, thus generating the high-frequency-emphasized video signal; and
an encoder to apply orthogonal transform coding to the high-frequency-emphasized video signal per block of the picture, thus generating the bitstream of the video signal.

6. A video de-emphasis decoding apparatus for decoding a bitsteam to obtain decoded high-frequency-emphasized video signal, the bitstream being produced by emphasizing spatial high-frequency components of a video signal in accordance with the levels of the high-frequency components to generate a high-frequency-emphasized video signal and encoding the high-frequency-emphasized video signal, and the method further de-emphasizing emphasized high-frequency components of the decoded high-frequency-emphasized video signal, thus obtaining a decoded video signal, the apparatus comprising:
a decoder to apply inverse orthogonal transform decoding to the bitsteam per block of a picture carried by the video signal, to obtain the decoded high-frequency-emphasized video signal;
a detector to detect spatial high-frequency components related to the decoded high-frequency-emphasized video signal, per portion of the picture;
a level setter to set a high-frequency-component de-emphasizing level related to the decoded high-frequency-emphasized video signal, per portion of the picture, in accordance with levels of the detected high-frequency components; and
a de-emphasizer to de-emphasize the detected high-frequency components, per portion of the picture, in accordance with the set high-frequency-component de-emphasizing level, thus obtaining the decoded video signal.

7. A video-emphasis transmitting method of generating a high-frequency-emphasized video signal by emphasizing high-frequency components of an input video signal and encoding the high-frequency-emphasized video signal, thus generating a bitstream of the video signal, and transmitting the bitstream as packets, the method comprising the steps of:
detecting spatial high-frequency components related to the input video signal, per portion of a picture carried by the input video signal;
setting a high-frequency-component emphasizing level related to the video signal, per portion of the picture, in accordance with levels of the detected high-frequency components;
emphasizing the detected high-frequency components in accordance with the set high-frequency-component emphasizing level, thus generating the high-frequency-emphasized video signal;
applying orthogonal transform coding to the high-frequency-emphasized video signal per block of the picture, thus generating the bitstream of the video signal; and
forming the packets of the bitstream per data amount, thus generating a packet multiplex signal.

8. A video de-emphasis receiving method of decoding a transmitted packet signal carrying a bitsteam to obtain decoded high-frequency-emphasized video signal, the bitstream being produced by emphasizing spatial high-frequency components of a video signal in accordance with the levels of the high-frequency components to generate a high-frequency-emphasized video signal and encoding the high-frequency-emphasized video signal, and the method further de-emphasizing emphasized high-frequency components of the decoded high-frequency-emphasized video signal, thus obtaining a decoded video signal, the method comprising the steps of:
extracting the bitstream from the packet signal;
applying inverse orthogonal transform decoding to the bitsteam per block of a picture carried by the video signal, to obtain the decoded high-frequency-emphasized video signal;
detecting spatial high-frequency components related to the decoded high-frequency-emphasized video signal, per portion of the picture;
setting a high-frequency-component de-emphasizing level related to the decoded high-frequency-emphasized video signal, per portion of the picture, in accordance with levels of the detected high-frequency components; and
generating the decoded video signal by de-emphasizing the detected high-frequency components, per portion of the picture, in accordance with the set high-frequency-component de-emphasizing level.

9. A video-emphasis transmitting apparatus for generating a high-frequency-emphasized video signal by emphasizing high-frequency components of an input video signal and encoding the high-frequency-emphasized video signal, thus generating a bitstream of the video signal, and transmitting the bitstream as packets, the apparatus comprising:
a detector to detect spatial high-frequency components related to the input video signal, per portion of a picture carried by the input video signal;
a level setter to set a high-frequency-component emphasizing level related to the video signal, per portion of the picture, in accordance with levels of the detected high-frequency components;
an emphasizer to emphasize the detected high-frequency components in accordance with the set high-frequency-component emphasizing level, thus generating the high-frequency-emphasized video signal;
an encoder to apply orthogonal transform coding to the high-frequency-emphasized video signal per block of the picture, thus generating the bitstream of the video signal; and
a packet former to form the packets of the bitstream per data amount, thus generating a packet multiplex signal.

10. A video de-emphasis receiving apparatus for decoding a transmitted packet signal carrying a bitsteam to obtain decoded high-frequency-emphasized video signal, the bitstream being produced by emphasizing spatial high-frequency components of a video signal in accordance with the levels of the high-frequency components to generate a high-frequency-emphasized video signal and encoding the high-frequency-emphasized video signal, and the method further de-emphasizing emphasized high-frequency components of the decoded high-frequency-emphasized video signal, thus obtaining a decoded video signal, the apparatus comprising:
an extractor to extract the bitstream from the packet signal;
a decoder to apply inverse orthogonal transform decoding to the bitsteam per block of a picture carried by the video signal, to obtain the decoded high-frequency-emphasized video signal;
a detector to detect spatial high-frequency components related to the decoded high-frequency-emphasized video signal, per portion of the picture;
a level setter to set a high-frequency-component de-emphasizing level related to the decoded high-frequency-emphasized video signal, per portion of the picture, in accordance with levels of the detected high-frequency components; and
a de-emphasizer to de-emphasize the detected high-frequency components, per portion of the picture, in accordance with the set high-frequency-component de-emphasizing level, thus generating the decoded video signal.
